(19) United States
(12) Patent Application Publication
(10) Pub. No.: US 2022/0068048 A1
(43) Pub. Date: Mar. 3, 2022

(54) Providing Data of a Motor Vehicle

(71) Applicants: Volkswagen Aktiengesellschaft, Wolfsburg (DE); AUDI AG, Ingolstadt (DE)

(72) Inventors: Stephan Max, Gifthorn (DE); Markus Stinner, Munich (DE)

(73) Assignees: Volkswagen Aktiengesellschaft, Wolfsburg (DE); AUDI AG, Ingolstadt (DE)

(21) Appl. No.: 17/463,745

(22) Filed: Sep. 1, 2021

(30) Foreign Application Priority Data
Sep. 2, 2020 (DE) 10 2020 122 895.3

(51) Int. Cl. G07C 5/00

(52) U.S. Cl. CPC G07C 5/008

(57) ABSTRACT

According to a method for providing data of a motor vehicle, a first dataset is generated by means of the motor vehicle and anonymized by means of a vehicle processor. The anonymized first dataset is communicated to a server system by means of the vehicle processor. Therein, the anonymization is effected based on a predetermined parameter set. By means of the server system, a degree of anonymization achieved by the anonymization is determined based on the anonymized first dataset, and an adapted parameter set is generated based on the degree of anonymization and communicated to the vehicle processor.

### CROSS-REFERENCE TO RELATED APPLICATIONS

This application claims priority to German Patent Application No. DE 10 2020 122 895.3, filed on Sep. 2, 2020 with the German Patent and Trademark Office. The contents of the aforesaid patent application are incorporated herein for all purposes.

### TECHNICAL FIELD

The present invention relates to a method for providing data of a motor vehicle, wherein a first dataset is generated by means of the motor vehicle, the first dataset is anonymized by means of a vehicle processor of the motor vehicle and the anonymized first dataset is communicated to a server system by means of the vehicle processor. Further, the invention relates to a corresponding server system for providing data of a motor vehicle and to a communication system.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

In the context of interconnected motor vehicles, vehicle systems are employed to send the data from a motor vehicle to a server backend. Therein, user related and not user related data is gathered and communicated. However, only not user related data is required for many applications or user related data is only required to a low extent and in restricted or anonymized form, respectively. Therein, exemplary uses of data not related to a person may involve the establishment of a weather map with measurement data from a vehicle fleet, the establishment of a traffic flow map from motion data of the vehicle fleet, the central warning of recognized danger spots, such as for example glazed frost or accidents, and the like.

For example, communication data, position data of the motor vehicle, corresponding time stamps or vehicle identification data may be gathered and communicated as the user related data. This data may be insignificant for the described uses not related to user or only required to restricted extent. However, the user related data is gathered in terms of a safe communication or is partially required, such as for example in case of position data, to match the gathered dataset with a map.

In some approaches, all of the user related and not user related data is communicated to the server backend and anonymized in the server backend as early as possible. However, this has the disadvantage that the data transmission itself is not anonymously effected and user related data has to be transmitted via the corresponding air interface. This may be disadvantageous from points of view of the data safety as well as optionally for considerations of data protection law.

### SUMMARY

Against this background, a need exists to provide improved methods and systems for providing data of a motor vehicle, by which user related data may be protected with higher reliability.

The need is addressed by the subject matter of the independent claims. Embodiments of the invention are described in the dependent claims, the following description, and the drawings.

### BRIEF DESCRIPTION OF THE DRAWINGS

FIG. 1 shows a schematic representation of an exemplary embodiment of an improved communication system;

FIG. 2 shows a flow diagram of an exemplary embodiment of an improved method; and

FIG. 3 shows a flow diagram of a further exemplary embodiment of an improved method.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments of the teachings herein are based on the idea to determine a degree of anonymization based on an anonymized dataset, which has been communicated from the motor vehicle to a server system, and to adapt a parameter set for anonymization depending thereon and to communicate it to the motor vehicle.

According to a first exemplary aspect, a method for providing data of a motor vehicle is provided, wherein a first dataset is generated by means of the motor vehicle and the first dataset is anonymized by means of a vehicle processor (also referred herein as ‘vehicle computing unit’) of the motor vehicle and the anonymized first dataset is, for example wirelessly, communicated to a server system by means of the vehicle processor. Therein, the anonymization is performed by means of the vehicle processor based on a predetermined parameter set. By means of the server system, a degree of anonymization, which is achieved by the anonymization, is determined based on the communicated anonymized dataset. By means of the server system, an adapted parameter set is generated based on the degree of anonymization, and for example based on the parameter set, and communicated, for example wirelessly communicated, to the vehicle processor.

For example, the first dataset generated by means of the motor vehicle may be generated by one or more sensor systems of the motor vehicle and/or by the processor. Therein, the dataset may for example include user related data or data capable of being related to a user as well as data without user relation. Therein, user related data may for example be understood as data, which allows or may allow conclusions regarding the identity of the motor vehicle or a user, for example an owner, of the motor vehicle. Thus, the user related data may for example contain data related to the motor vehicle and/or related to the person. The user related data may for example include an IP address of the vehicle processor or of a communication interface of the vehicle processor, a network card identification number of the vehicle processor, other device identification numbers of components of the vehicle processor or of the motor vehicle, a vehicle identification number, VIN, a user identification number, a customer number of the user, and so on. The user related data may also include data concerning one or more positions of the motor vehicle, for example a route driven or planned by means of the motor vehicle, and/or time stamps concerning sensor data or position data.

The data without relation to user may for example include measurement data, raw data or preprocessed measurement and raw data of the sensor system, respectively, weather data of the environment of the motor vehicle or operating data of the motor vehicle, for example a motor vehicle speed or activity information concerning components of the motor vehicle, such as for example a heating device, an air conditioner, windshield wipers or a lighting device of the motor vehicle.

Anonymizing the first dataset may for example comprise completely or partially removing or deleting the user related data, modifying the user related data and/or concealing the user related data, for example position data and points of time or periods of time. If the first dataset for example contains positional courses or routes, thus, the vehicle processor may remove parts of the route, for example a start area and/or destination area of the route, for anonymizing. Therein, it is for example predetermined by the parameter set, which parts of the first dataset are removed, modified or concealed and how the modification or concealment is performed, respectively, and how severe the concealment or the modification is, respectively.

The degree of anonymization may then be regarded as a measure for an effort, for example a computing effort, which is required to associate the anonymized first dataset or parts thereof with the motor vehicle or the user of the motor vehicle, thus to perform a reidentification. Therein, the parameter set for example has a direct influence on the achieved degree of anonymization. Therein, the predetermined parameter set is for example also present on the server system or is for example predetermined by the server system.

The server system is for example a system arranged externally to the motor vehicle and independent of the motor vehicle, which comprises one or more server processors and/or server processing circuits (also referred herein as ‘server computing units’). For example, the server system may include multiple, optionally spatially distributed, server processors and/or server processing circuits independent of each other and being in a wireless communication link with each other.

Thus, by the method according to the first aspect, quality control of the anonymization of the first dataset performed in the motor vehicle may be realized by the determination of the degree of anonymization and, if applicable, by the adaptation of the parameter set. In that the anonymization is effected in the motor vehicle or by the motor vehicle, less data related to a person or related to a motor vehicle is transmitted via the air interface between vehicle processor and server system such that a risk of misuse is already thereby reduced. However, the effort required for the anonymization to achieve a desired degree of anonymization may be different according to the situation. For example, if a very large number of motor vehicles, of which corresponding data is gathered, is in a certain spatial and/or temporal range, already a relatively low effort in the anonymization may for example result in the fact that the anonymized first dataset may be associated with the actually generating motor vehicle only with considerable effort. In contrast, if only very few motor vehicles providing data are present in the spatial and/or temporal range, thus, a higher effort, for example a more severe concealment or a more comprehensive removal of data parts capable of being related to user, may be required to achieve the desired degree of anonymization. For example, a certain group or fleet anonymity may be achieved by the anonymization such that the anonymized first dataset may be associated with a vehicle group of a certain size, but not with a specific motor vehicle of the group or fleet. According to the size of the group, therefore, the degree of anonymization may vary, wherein the degree of anonymization may for example also be given by the size of the group. The size of the group may be influenced based on the parameter set.

Thus, the improved concept allows for adapting the anonymization effort to the concretely present situation and thereby achieving a higher reliability in the anonymization and in achieving the desired degree of anonymization, respectively, and therein keeping the effort for anonymization as low as possible.

In some embodiments, the first dataset is generated by means of the vehicle processor and/or the sensor system of the motor vehicle, wherein the sensor system for example includes one or more environmental sensor systems.

Here and in the following, an environmental sensor system may be understood as a sensor system, which is capable of generating sensor data or sensor signals, which image, represent or reproduce an environment of the motor vehicle. For example, cameras, lidar systems, radar systems and ultrasonic sensor systems may be regarded as environmental sensor systems.

The first dataset may also include position data, which is generated by means of a digital map system of the motor vehicle and/or by means of a receiver for a global navigation satellite system, GNSS, of the motor vehicle.

In some embodiments, the anonymized first dataset and/or data depending thereon is provided for use by means of the server system. Therein, the use may be effected by the server system itself or by a further entity, which has access to the anonymized first dataset and the data depending thereon, respectively, for example a further computing unit/processor or a further person.

In some embodiments, a group size is determined by means of the server system based on the anonymized first dataset, which corresponds to a number of motor vehicles, to which the anonymized dataset may be related. The degree of anonymization is determined depending on the group size or corresponds to the group size.

For example by the concealment of location and/or time information of the first dataset for anonymizing, a group anonymity may be generated since the corresponding anonymized first data may then be related to an entire group of motor vehicles, but it cannot be determined, which motor vehicle of the group has actually generated the first dataset. The larger the group, the safer the anonymized first dataset is from misuse since the effort to associate the first dataset with one of the motor vehicles increases with the number of motor vehicles of the group.

Therefore, by the adaptation of the parameter set depending on the group size, the group size achieved by the anonymization may be adapted to achieve the desired degree of anonymization, wherein the desired degree of anonymization for example involves or corresponds to a predetermined limit value for the group size or for the number of motor vehicles.

In some embodiments, a second dataset is generated by means of the motor vehicle and the second dataset is anonymized by means of the vehicle processor based on the adapted parameter set. The anonymized second dataset is communicated to the server system by means of the vehicle processor.

The explanations with respect to the first dataset and the parameter set analogously apply to the second dataset and the adapted parameter set. After the parameter set has been adapted, it is to be expected that a degree of anonymization, which is achieved by the anonymization of the second dataset based on the adapted parameter set, is increased. Thereby, the data safety concerning the second dataset and further analogously generated and anonymized datasets, respectively, may be improved.

In some embodiments, the motor vehicle is part of a motor vehicle fleet including one or more further motor vehicles, and the adapted parameter set is communicated to a respective further vehicle processor of each further motor vehicle of the motor vehicle fleet by means of the server system.

Thereby, it may for example be achieved that all of the motor vehicles of the motor vehicle fleet may anonymize corresponding datasets respectively based on the same adapted parameter set. Thereby, the parameter set and the corresponding degree of anonymization, respectively, may be proactively adapted and the reliability and data safety for the entire motor vehicle fleet may thus be increased.

In some embodiments, a further dataset is generated by means of each further motor vehicle of the motor vehicle fleet and the respective further dataset is anonymized based on the adapted parameter set by means of the respective further vehicle processor. The respective anonymized further dataset is communicated to the server system by means of the respective further vehicle processor.

The correspondingly communicated further anonymized datasets may be further processed or provided for use analogously to the communicated anonymized first dataset.

In some embodiments, further user related data is communicated to the server system together with the anonymized first dataset by means of the vehicle processor, and the communicated further user related data is deleted by means of the server system.

Therein, the further user related data may for example include data, which has to be necessarily communicated for correct and safe transmission of the anonymized first dataset, for example an IP address of the vehicle processor and/or a customer identification number. The server system deletes this further user related data to thus prevents a possible reidentification of the motor vehicle or of the user based on the anonymized first dataset. For example, the server system deletes all of the data communicated from the vehicle processor together with the anonymized first dataset except for the anonymized first dataset.

In some embodiments, the further user related data includes the IP address of the vehicle processor and/or an identifier associated with the vehicle processor.

Therein, the identifier associated with the vehicle processor may include a customer identification number or a vehicle identification number.

In some embodiments, the further user related data and the anonymized first dataset are communicated to a first server processing circuit of the server system by means of the vehicle processor, and the communicated user related data is deleted by means of the first server processing circuit. The anonymized first dataset is, for example wirelessly, communicated to a second server processing circuit of the server system by means of the first server processing circuit, wherein the second server processing circuit is for example physically and/or spatially separated from the first server processing circuit.

The data safety may be further increased by the separation of the first from the second server processing circuit, since the second server processing circuit does not have the further user related data at any point of time. Thus, a potentially abusive use of the anonymized first dataset would require an unauthorized access to two different server processing circuits independent of each other. Therein, the first server processing circuit may be regarded as an intermediate backend, which forwards the anonymized first dataset to the second server processing circuit as a destination backend.

In some embodiments, the degree of anonymization is determined by means of the second server processing circuit, and the adapted parameter set is generated by means of the second server processing circuit and communicated to the vehicle processor.

In some embodiments, the anonymized first dataset is encrypted by means of the vehicle processor before the communication thereof to the server system. The encrypted first anonymized first dataset is decrypted by means of the server system, for example by means of the second server processing circuit, after deleting the further user related data.

Thereby, it is ensured that the first anonymized dataset is only present in encrypted form on the server system at the same time with the further user related data. Thereby, the data safety is further increased.

In some embodiments, a success of deleting the further user related data is examined by means of the server system, for example by means of the second server processing circuit, before decryption and the decryption is performed depending on a result of the examination.

For example, the decryption is performed only if or exactly if the deletion of the further user related data was successful according to the result of the examination. Thereby, the probability may be reduced that a part of the further user related data is present on the server system at the same time with the decrypted anonymized first dataset for unpredictable reasons.

In some embodiments, the predetermined parameter set contains a delay period and the anonymized first dataset is communicated to the server system delayed in time according to the delay period by means of the vehicle processor.

In other words, the anonymized first dataset is, optionally in encrypted manner, available for communication to the server system at a certain point of time, however, the actual communication is effected delayed in time according to the delay period with respect to this point of time. Thereby, a capability of association of the anonymized first dataset with the motor vehicle and with the user thereof, respectively, is further aggravated and the group size may be further increased, respectively. Thereby, the reliability of the method and the data safety, respectively, are further increased.

The adaptation of the parameter set and the generation of the adapted parameter set, respectively, for example involve the adaptation of the delay period. The second dataset is for example communicated to the server system delayed in time according to the adapted delay period.

According to a second exemplary aspect, a server system for providing data of a motor vehicle is specified, wherein the server system comprises at least one server processor, which is configured to obtain an anonymized first dataset, which is for example anonymized based on a predetermined parameter set, from the motor vehicle or from a vehicle processor of the motor vehicle. The at least one server processor is configured to determine a degree of anonymization achieved by the anonymization, for example based on the parameter set, based on the anonymized first dataset and to generate an adapted parameter set based on the degree of anonymization and for example on the parameter set and to communicate it to the motor vehicle or the vehicle processor.

In some embodiments of the server system, the at least one server processor comprises a first server processing circuit and a second server processing circuit. The first server processing circuit is configured to obtain user related data together with the anonymized first dataset from the motor vehicle or the vehicle processor, to delete the communicated user related data and to communicate the anonymized first dataset to the second server processing circuit.

Further embodiments of the server system according to the present aspect directly follow from the various embodiments of the method according to the first exemplary aspect and vice versa.

According to another exemplary aspect, also a communication system is specified, which comprises a server system as discussed herein as well as a vehicle processor for the motor vehicle. The vehicle processor is configured to anonymize a first dataset generated by the motor vehicle based on a predetermined parameter set to generate the anonymized first dataset and to communicate the anonymized first dataset to the server system.

Further embodiments of the communication system a follow from the various embodiments of the method of the first exemplary aspect and vice versa. For example, a communication system may be configured to perform the method according to the first exemplary aspect.

The invention also includes combinations of the features of the described embodiments.

Reference will now be made to the drawings in which the various elements of embodiments will be given numerical designations and in which further embodiments will be discussed.

In the exemplary embodiments described herein, the described components of the embodiments each represent individual features that are to be considered independent of one another, in the combination as shown or described, and in combinations other than shown or described. In addition, the described embodiments can also be supplemented by features of the invention other than those described.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

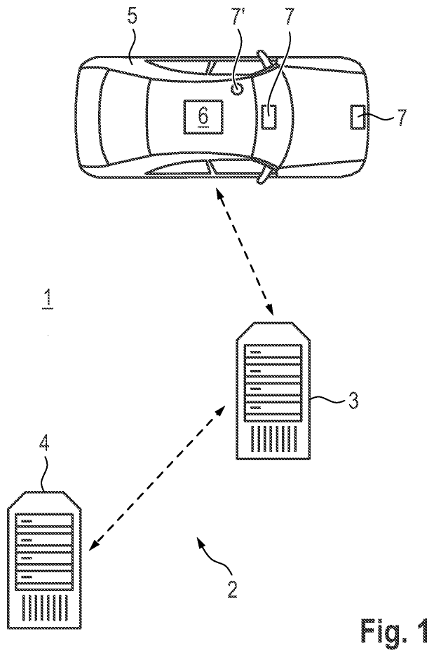

In FIG. 1, a schematic representation of an exemplary embodiment of a communication system 1 is illustrated, which includes a server system 2 and a vehicle processor 6 of a motor vehicle 5. In various embodiments, the motor vehicle 5 may be regarded as a part of the communication system 1. For example, the motor vehicle 5 comprises one or more sensor systems 7, for example environmental sensor systems, speed sensors, temperature sensors and so on, as well as a GNSS receiver 7′, for example a GPS, GLONASS, Galileo and/or Beidou receiver. The server system 2 includes at least one server processing circuit 3, 4. In various forms of configuration, the server system 2 includes a first server processing circuit 3 as well as a second server processing circuit 4, which is physically and spatially separated from the first server processing circuit 3.

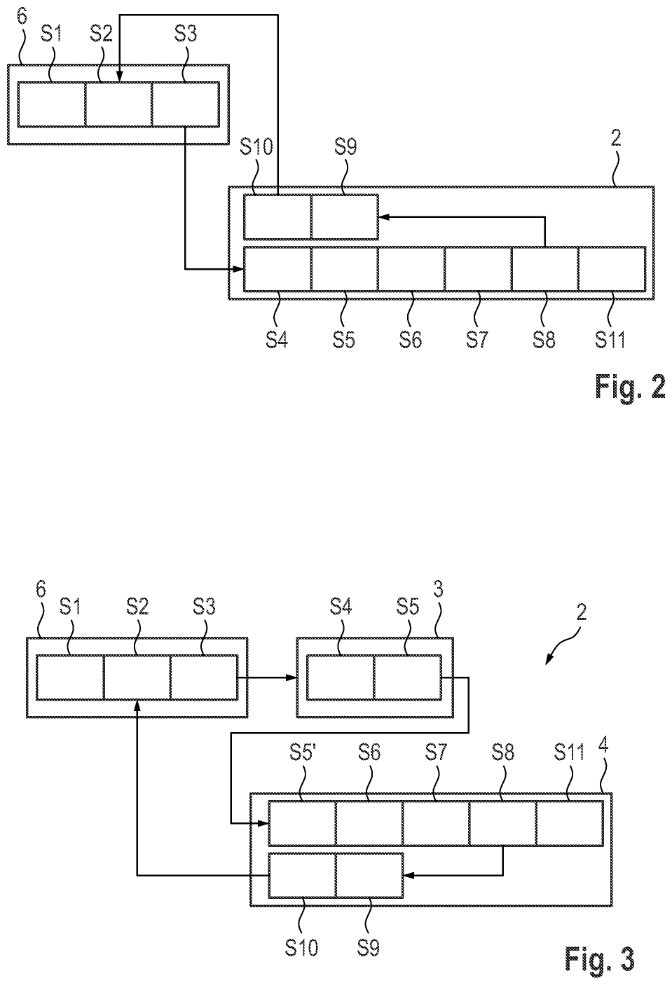

In the following, the functionality of the communication system 1 is explained in more detail based on exemplary embodiments of a method for providing data of the motor vehicle 5 according to the improved concept, for example with reference to FIG. 2 and FIG. 3.

In FIG. 2, a flow diagram of an exemplary embodiment of a method is schematically illustrated. The server system 2 as well as the vehicle processor 6 are also schematically illustrated.

In a first method step S1, data is gathered by means of the motor vehicle 5, for example based on the sensor systems 7 and/or the GNSS receiver 7′ as well as optionally by further components of the motor vehicle 5 and/or by means of the vehicle processor 6, which includes both not user related data, such as for example environmental sensor data, weather data or operating data of the motor vehicle, for example a motor vehicle speed, as well as user related data or capable of being related to user, such as for example communication data, position data of the motor vehicle 5, time stamps concerning the environmental sensor data or the position data, vehicle identification data like a VIN and so on.

In step S2, the gathered data is anonymized by means of the vehicle processor 6. Thereby, parts of the gathered data may for example be removed or deleted, such as for example the name of a user, information concerning an official license number of the motor vehicle 5 or other data immediately suitable for identification of the user or of the motor vehicle 5. Within the scope of the anonymization, data parts may also be removed, which may be indirectly used for identification of the user or motor vehicle, thus pseudonymous data. For example, start and/or destination positions of routes traveled or planned by means of the motor vehicle 5 may be removed.

In addition, the anonymization may involve concealing position data of the motor vehicle 5, which has for example been generated or determined based on map information or on signals received by means of the GNSS receiver 7′ and/or concealing corresponding points of time, at which the motor vehicle 5 was located in the corresponding positions. Therein, the concealment may be effected by artificially adding tolerances or errors or by temporally delayed processing or uploading the data to the server system 2. Time stamps of the position data may also be correspondingly removed.

The specific measures for anonymization finally depend on the fact for which purpose the data of the motor vehicle 5 is to be used. For example, if the data is to serve to establish a traffic flow map or a weather map or the like, thus, position data and optionally also time data or temporal information is required, at least to a certain extent. Therefore, the anonymization is effected based on a predetermined parameter set, which determines, which parts of the data are to be removed or concealed and how severely the concealment is to be performed. The vehicle processor 6 may for example obtain the parameter set from the server system 2.

By the anonymization, a group anonymization is for example achieved such that the motor vehicle 5 is no longer uniquely identifiable in a motor vehicle fleet with further motor vehicles.

In step S3, the anonymized data is encrypted by means of the vehicle processor 6. In step S4, the encrypted anonymized data is communicated to the server system 2. Therein, further user related data is for example also communicated, for example an IP address of the vehicle processor 6, besides the anonymized data.

In step S5, this further user related data is therefore deleted by means of the server system 2. Therein, the deletion is for example effected without the encrypted anonymized data being previously decrypted. In the optional step S6, the success of the deletion may be examined and only if it is determined that all of the user related data, which has been communicated together with the anonymized data, has been removed, the data is passed and further processed, respectively. After deleting the user related data, the encrypted anonymized data is decrypted by the server system 2 in step S7.

In step S8, a quality inspection of the anonymization may be performed. Thereto, a degree of anonymization achieved by the anonymization may for example be determined by means of the server system 2 and for example be compared to a predetermined limit value for the degree of anonymization. Depending on a result of the comparison, the parameter set for anonymizing the data may be adapted in step S9. Thereby, the efficiency or efficacy of the anonymization may be improved or gradually improved.

In step S10, the adapted parameter set is communicated to the vehicle processor 6 and to corresponding vehicle processors of the further motor vehicles of the motor vehicle fleet, respectively. For further anonymizations, the vehicle processor 6 may then use the adapted parameter set. In step S11, the anonymized data is supplied to its intended use and provided for the use by third parties, respectively, by means of the server system 2.

In various embodiments, the encryption in step S3 and the decryption in step S7 are not performed.

In FIG. 3, a flow diagram of a further exemplary embodiment of a method according to the improved concept is illustrated. The method according to FIG. 3 largely corresponds to the method with respect to FIG. 2. However, in the embodiment of the method according to FIG. 3, the server system 2 comprises the first server processing circuit 3 as well as the second server processing circuit 4.

Therefore, the anonymized and optionally encrypted data as well as the further user related data is communicated from the vehicle processor 6 to the first server processing circuit 3 in step S4. The step S5 for deleting the further user related data is performed by the first server processing circuit 3, and the anonymized data is communicated from the first server processing circuit 3 to the second server processing circuit 4 without any further user related data in step S5′. The steps S6 to S11 correspond to the steps explained with respect to FIG. 2 and are executed by the second server processing circuit 4.

By the physical and organizational separation of the server processing circuits 3 and 4, a possible attacker may be prevented from gaining access both to the decrypted anonymized data and to the further user related data.

As explained, for example with respect to the FIGS., the teachings herein allow improving the data safety of data related to person or related to motor vehicle upon the use of data of a motor vehicle and increasing the reliability of the data protection.

### LIST FOR REFERENCE NUMERALS

1 Communication system
2 Server system
3,4 Server processing circuits
5 Motor vehicle
6 Vehicle processor
7 Sensor systems
7′ GNSS receiver
S1 to S11 Method steps

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for providing data of a motor vehicle, comprising:
generating a first dataset by the motor vehicle;
anonymizing the first dataset by a vehicle processor of the motor vehicle; and
communicating the anonymized first dataset to a server system by the vehicle processor; wherein
the anonymization is performed based on a predetermined parameter set;
a degree of anonymization achieved by the anonymization is determined by the server system based on the anonymized first dataset; and
an adapted parameter set is generated based on the degree of anonymization and communicated to the vehicle processor by the server system.

2. The method of claim 1, wherein
user related data is communicated to the server system together with the anonymized first dataset by the vehicle processor; and
the communicated user related data is deleted by the server system.

3. The method of claim 2, wherein the user related data comprises one or more of: an IP address of the vehicle processor, and an identifier associated with the vehicle processor.

4. The method of claim 2, wherein
the user related data and the anonymized first dataset are communicated to a first server processing circuit of the server system by the vehicle processor;
the communicated user related data is deleted by the first server processing circuit; and
the anonymized first dataset is communicated to a second server processing circuit of the server system by the first server processing circuit.

5. The method of claim 4, wherein
the degree of anonymization is determined by the second server processing circuit; and
the adapted parameter set is generated by the second server processing circuit and communicated to the vehicle processor.

6. The method of claim 2, wherein
the anonymized first dataset is encrypted by the vehicle processor before communication thereof to the server system; and
the encrypted anonymized first dataset is decrypted by the server system after deleting the user related data.

7. The method of claim 6, wherein
before decryption, a success of deletion of the user related data is examined by the server system; and
the decryption is performed depending on a result of the examination.

8. The method of claim 1, wherein the predetermined parameter set comprises a delay period and the anonymized first dataset is communicated to the server system delayed in time according to the delay period by means of the vehicle processor.

9. The method of claim 1, wherein a group size is determined by the server system based on the anonymized first dataset, which corresponds to a number of motor vehicles, to which the anonymized dataset may be related, and the degree of anonymization is determined depending on the group size.

10. The method of claim 1, wherein
a second dataset is generated by the motor vehicle and the second dataset is anonymized by the vehicle processor based on the adapted parameter set; and
the anonymized second dataset is communicated to the server system by the vehicle computing processor.

11. The method of claim 1, wherein
the motor vehicle is part of a motor vehicle fleet, which includes one or more further motor vehicles; and
the adapted parameter set is communicated to a respective further vehicle processor of each further motor vehicle of the motor vehicle fleet by the server system.

12. The method of claim 11, wherein
a further dataset is generated by each further motor vehicle of the motor vehicle fleet and the respective further dataset is anonymized by the respective further vehicle processor based on the adapted parameter set; and
the respective anonymized further dataset is communicated to the server system by the respective further vehicle processor.

13. A server system for providing data of a motor vehicle, the server system comprising at least one server processor, which is configured to obtain an anonymized first dataset from the motor vehicle, wherein
the at least one server processor is configured
to determine a degree of anonymization achieved by the anonymization based on the anonymized first dataset; and
to generate an adapted parameter set based on the degree of anonymization and to communicate it to the motor vehicle.

14. The server system of claim 13, wherein
the at least one server processor comprises a first server processing circuit and a second server processing circuit;
the first server processing circuit is configured to obtain user related data from the motor vehicle together with the anonymized first dataset, to delete the communicated user related data and to communicate the anonymized first dataset to the second server processing circuit.

15. A communication system comprising a server system of claim 13 as well as a vehicle processor for the motor vehicle, wherein the vehicle processor is configured
to anonymize a first dataset generated by the motor vehicle based on a predetermined parameter set to generate the anonymized first dataset; and
to communicate the anonymized first dataset to the server system.

16. The method of claim 3, wherein
the user related data and the anonymized first dataset are communicated to a first server processing circuit of the server system by the vehicle processor;
the communicated user related data is deleted by the first server processing circuit; and
the anonymized first dataset is communicated to a second server processing circuit of the server system by the first server processing circuit.

17. The method of claim 16, wherein
the degree of anonymization is determined by the second server processing circuit; and
the adapted parameter set is generated by the second server processing circuit and communicated to the vehicle processor.

18. The method of claim 3, wherein
the anonymized first dataset is encrypted by the vehicle processor before communication thereof to the server system; and
the encrypted anonymized first dataset is decrypted by the server system after deleting the user related data.

19. The method of claim 4, wherein
the anonymized first dataset is encrypted by the vehicle processor before communication thereof to the server system; and
the encrypted anonymized first dataset is decrypted by the server system after deleting the user related data.

20. The method of claim 5, wherein
the anonymized first dataset is encrypted by the vehicle processor before communication thereof to the server system; and
the encrypted anonymized first dataset is decrypted by the server system after deleting the user related data.
